(19) United States
(12) Patent Application Publication
(10) Pub. No.: US 2019/0235632 A1
(43) Pub. Date: Aug. 1, 2019

(54) METHOD AND SYSTEM FOR CONTROLLING THE DISPLAY OF INFORMATION AND USER TERMINAL IMPLEMENTING THIS METHOD

(71) Applicant: THALES, Courbevoie (FR)

(72) Inventor: Hélène, Marguerite, Marie, Thérèse SOUBARAS, Palaiseau (FR)

(21) Appl. No.: 16/320,460

(22) PCT Filed: Jul. 17, 2017
(86) PCT No.: PCT/EP2017/068041

§ 371 Date: Jan. 24, 2019

(30) Foreign Application Priority Data
Jul. 28, 2016 (FR) 16 01164

(51) Int. Cl. G06F 3/01; G06F 3/0484

(52) U.S. Cl. CPC G06F 3/017; G06F 3/04845; G06F 3/012

(57) ABSTRACT

This method for controlling the display of at least one image on at least one screen of a terminal associated with means for viewing a scene, is characterized in that it includes a step of establishing a reference display configuration in which the display of the image is associated with the view of the scene output by the viewing means, and a step of detecting changes in the view of the scene output by the viewing means, in order to control changes to the display of the image on the screen accordingly.

The present invention relates to a method for controlling the display of at least one image on a screen of a terminal associated with means for capturing a scene.

The invention also relates to a control system, for carrying out such a method, and a user terminal, provided with such a control system.

The terminals of this kind that are the best known in the state of the art are for example made up of tablets, smartphones, information display monitors or computers, or even smart watches or the like.

Different builders and developers have already proposed methods and means making it possible to modify the display of an image on the screen of such a terminal.

Thus for example, it is known that it is possible to modify the display magnification/reduction factor of an image on a screen or to scroll images or change region of interest of the image displayed on the screen.

This is for example obtained by tactile interaction for example between the user of the terminal and the latter's screen.

As an example, a change in the display magnification/reduction factor of the image on a touchscreen can be obtained for example by a user thereof, by placing two fingers on the touchscreen and separating them or bringing them closer together to change the display factor and obtain the desired display factor.

Likewise, the area of interest of an image displayed on the screen of the terminal can also be modified by a user, for example when the latter places his finger on the screen and moves it while remaining pressed on said screen, in order to scroll the area of the image displayed on the screen.

An analysis of the user's gestures by viewing means also makes it possible to obtain such commands.

Many other control modes of such a display are also known in the state of the art.

However, all of these known means have a certain number of drawbacks, in particular in terms of their implementation, which most often requires the user of the terminal to be extremely available.

In particular, a large portion of the means known in the state of the art requires both of the user's hands to be available, so that one hand can be used to hold the terminal and the other hand can enter the required commands.

Yet some situations exist in which this is not possible, for example when the user is in a public transportation vehicle and must hold any holding member thereof.

The aim of the invention is therefore to resolve these problems by proposing various means making it possible to further simplify this display command.

To that end, the invention relates to a method for controlling the display of at least one image on at least one screen of a terminal associated with means for viewing a scene, characterized in that it includes a step of establishing a reference display configuration in which the display of the image is associated with the view of the scene output by the viewing means, and a step of detecting changes in the view of the scene output by the viewing means, in order to control changes to the display of the image on the screen accordingly.

According to other features of the method according to the invention, considered alone or in combination:
the detection step further consists of detecting:
   a change in the view of the scene at the output of the viewing means consisting, along an axis substantially perpendicular to the plane of the screen and/or along an aiming axis of the viewing means, of a translation in one direction or another from a reference position corresponding to the reference view, to modify the display enlargement/reduction factor of the image on the screen accordingly,
   a change in the view of the scene at the output of the viewing means, in a plane substantially parallel to that of the screen and/or in a plane substantially perpendicular to an aiming axis of the viewing means, in one direction or another from a reference position corresponding to the reference view, to modify a region of interest of the image, displayed on the screen, accordingly,
   a rotation of the view of the scene at the output of the viewing means, around an axis substantially perpendicular to the plane of the screen and/or an aiming axis of the viewing means, in one direction or the other from a reference position corresponding to the reference view, to command a rotation of the image displayed on the screen accordingly, and/or
   an angular pivoting of the view of the scene at the output of the image acquisition means, in one direction or the other from a reference position corresponding to the reference view, around an axis comprised in the plane of the screen or perpendicular to the aiming axis, to command a translation of the image displayed on the screen accordingly;
it is activated by an action by a user of the terminal;
the activation action by the user is an action on the screen of the terminal;
the activation action by the user is an action on a pushbutton of the terminal;
the scene is the environment opposite the screen;
the environment scene opposite the screen incorporates the head of a user of the terminal.

According to another aspect, the invention also relates to a system for controlling the display of at least one image on at least one screen of a terminal associated with means for viewing a scene, for implementing a method as previously described, characterized in that it includes means for establishing a reference display configuration in which the display of the image is associated with the view of the scene output by the viewing means, and means for detecting changes in the view of the scene output by the viewing means, in order to control changes to the display of the image on the screen accordingly.

According to still another aspect, the invention also relates to a user terminal, provided with a system for controlling a display as previously described.

According to other features of the terminal according to the invention, considered alone or in combination:
it includes integrated viewing means;
it includes remote viewing means connected to it by connection means;
the connection means are chosen from the group comprising connection means that are:
   wired,
   wireless,
   infrared;
it is chosen from the group comprising:
   an information display monitor,
   a computer,
   a tablet,
   a smart watch,
   a smartphone.

The invention will be better understood upon reading the following description, provided solely as an example, and in reference to the appended drawings, in which:

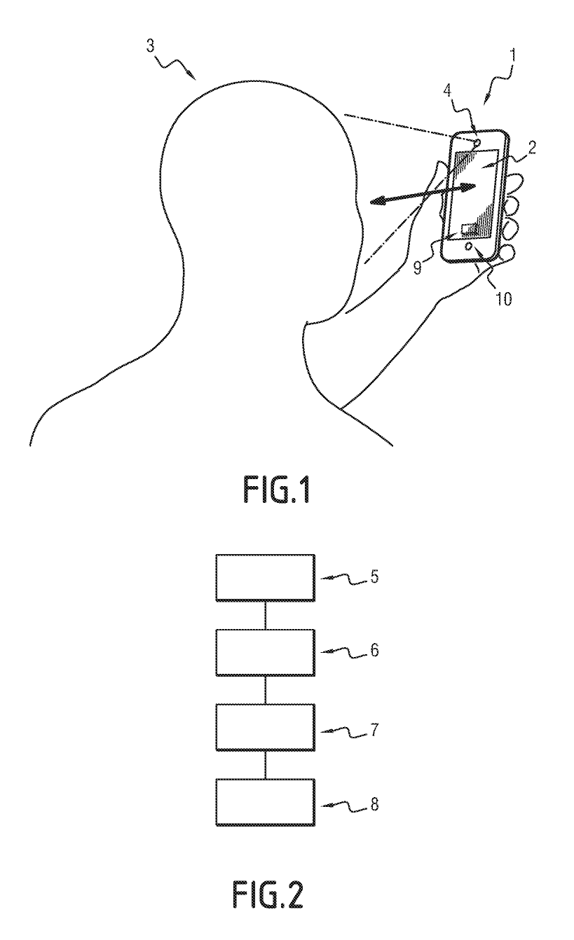

FIG. 1 shows a block diagram illustrating an example embodiment of a method according to the invention;

FIG. 2 shows a flowchart illustrating different steps of such a method;

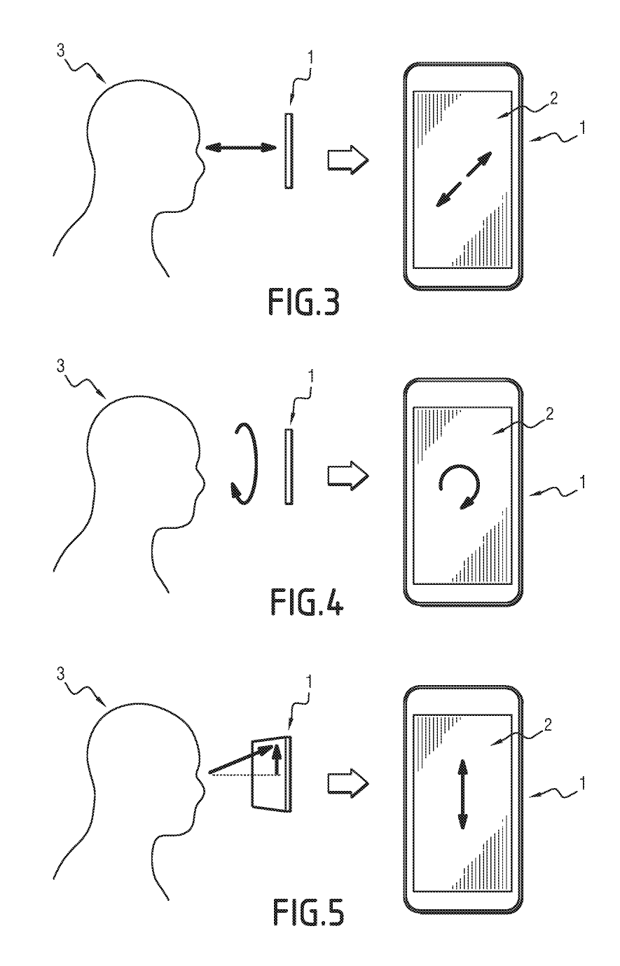

FIGS. 3, 4, 5 and 6 illustrate different display commands that can be implemented using such a method; and

FIGS. 7 and 8 show alternative embodiments of a terminal implementing a control system according to the invention.

These figures, and in particular FIGS. 1 and 2, generally show a method, a system and a user terminal implementing a display command according to the invention.

FIG. 1 indeed shows a user terminal designated by general reference 1, provided with an information display screen, designated by general reference 2.

This user terminal is for example made up, in the described example, of a smartphone or a tablet, for example including a touchscreen or the like.

Of course, other terminals such as an information display monitor, a computer, a smart watch, etc. can be considered.

In general, such a terminal 1 equipped with its screen 2 is made available to a user such as a user 3, in order to view information on the screen, said information for example being made up of at least one image.

Furthermore, said terminal 1 is associated with means for viewing a scene, said viewing means for example being made up of a camera or any other device of this type, and being designated by general reference 4 in this figure.

In the example embodiment described in this FIG. 1, these viewing means 4 are directly integrated into the terminal 1, for example on the same face thereof as the screen, and are therefore suitable for taking a view of the scene made up of the environment opposite said screen 2.

Thus in the described example, the environment scene opposite the screen incorporates the head of the user of the terminal.

Indeed, the latter then looks at the screen.

Indeed and in the method according to the invention, as described in FIG. 2, a step is provided for activation/initialization of the method by the user, designated by general reference 5 in this FIG. 2, which then makes it possible to establish a reference display configuration for the information on the screen.

In this reference display configuration, the display of the image is associated with the view of the scene at the output of the viewing means.

This step for establishing the reference configuration is designated by general reference 6 in this FIG. 2.

Then, one carries out a step for detecting changes in the view of the scene at the output of the viewing means, in 7, by analyzing output signals thereof, to control changes of the display of the image on the screen accordingly.

This step for controlling changes in the display of the image is designated by general reference 8 in this FIG. 2.

Indeed and if we return to FIG. 1, the method according to the invention can be activated by an action by a user of the terminal.

This action may for example be an action on an area of the terminal, which for example may or may not be specific, as designated by general reference 9 in this FIG. 1, if said terminal is for example a terminal with a touchscreen.

The user may then thus activate the method according to the invention and in particular the first step for establishing the reference configuration, quite simply by pressing on the touchscreen.

Other ways of activating this method and the corresponding system can of course be considered.

Thus, the user can also press with a finger, for example on a pushbutton of the terminal, this pushbutton being designated by general reference 10 in this FIG. 1.

One can then see that, according to the example embodiment just described, during this first operating phase of the method and system for controlling a display according to the invention, the user of the terminal looks at the screen thereof and the viewing means acquire a view of the scene opposite said screen and in particular the head of the user.

When the user activates the method and the system according to the invention, by pressing on the touchscreen or on the pushbutton of the terminal, he then triggers the establishment by the system of a reference display configuration, in which the display of the image is associated with the view of the scene at the output of the viewing means.

The system next monitors the view of the scene at the output of the viewing means, to detect changes in the view of said scene in order to control changes of the display of the image on the screen accordingly.

FIGS. 3, 4, 5 and 6 show such detections and such modifications of the display of the image on the screen.

In these FIGS. 3, 4, 5 and 6, one can see the terminal 1, the user 3 and the screen 2 of the terminal 1.

These various figures indeed illustrate the consequences, in terms of display of information on the screen, of detections in changes of the view of the scene.

Thus for example in FIG. 3, the detection consists of further detecting a change in the view of the scene at the output of the viewing means, along an axis substantially perpendicular to the plane of the screen and/or along an aiming axis of the viewing means, associated with a translation in one direction or another from the reference position corresponding to the reference view, to modify the display enlargement/reduction factor of the image on the screen accordingly.

Indeed, by pressing on the activation button, the user of the terminal defines a reference position/distance for example of his head relative to the screen.

If the distance becomes larger or smaller because the user decides to move closer to or on the contrary further from the screen, the system according to the invention will detect these changes and modify the display magnification/reduction factor of the image on the screen accordingly.

Indeed, it is possible to consider that if the distance between the user's head and the screen becomes smaller, it is because the user wishes to observe a detail of the displayed image, and the displayed image should then be magnified.

On the contrary, when the distance between the user's head and the screen becomes larger, it may be considered that the user wishes to reduce the displayed image in order to have an overview thereof.

These are of course only example considerations.

Other changes may thus be analyzed, as illustrated in FIG. 4.

Indeed, one may thus for example detect a rotation of the view of the scene at the output of the viewing means, around an axis substantially perpendicular to the plane of the screen and/or the aiming axis of the viewing means, in one direction or in another from the reference position corresponding to the reference view, to command a rotation of the image displayed on the screen accordingly, as illustrated in this FIG. 4.

FIG. 5 shows the detection of an angular pivoting of the view of the scene at the output of the viewing means in one direction or another around an axis comprised in the plane of the screen from the reference position corresponding to the reference view, to command a translation of the image displayed on the screen accordingly just as the image returned by a mirror moves when a rotation is applied to it.

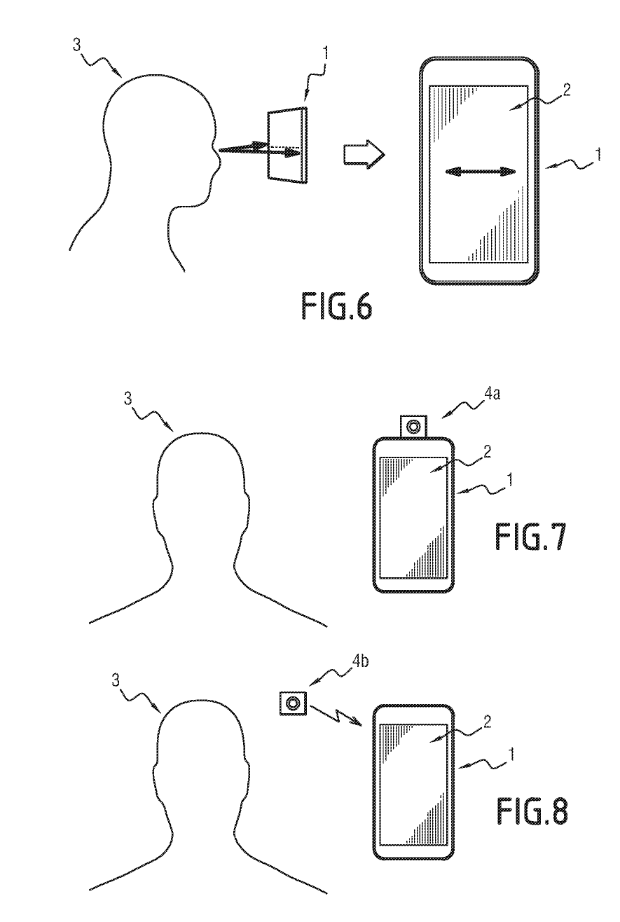

Lastly, FIG. 6 shows a change in the view of the scene at the output of the viewing means by detection of a movement in a plane substantially parallel to that of the screen and/or in a plane substantially perpendicular to the aiming axis of the viewing means, in one direction or another from a reference position corresponding to the reference view, to modify a region of interest of the image, displayed on the screen, accordingly.

Indeed, multiple change detections, reflected by corresponding orders and display commands, can thus be defined.

In a method and a system according to the invention, the method should be defined and activated from a reference view as defined by the user, to next analyze changes in the view, and deduce control orders therefrom reflected by corresponding changes in the display of the image on the screen.

Of course, orders other than those described may be considered.

In the example described above in particular in FIG. 1, the viewing means are for example formed by a viewing device integrated into the terminal and placed for example on the face thereof also including the display screen.

Of course, other embodiments may be considered, for example as illustrated in FIGS. 7 and 8.

In FIGS. 7 and 8, the viewing means may not be integrated into the terminal 1 and be made up for example of a separate camera and connected thereto, like that designated by general reference 4a in this FIG. 7.

These viewing means may also be made up of completely separate means separated from the terminal, as illustrated in FIG. 8, where one can see the viewing means designated by general reference 4b, connected to the terminal.

In this case, the separate viewing means can be connected to said terminal by connecting means able to include, traditionally, wired, wireless or infrared connecting means, etc.

Of course, still other embodiments can be considered.

One can then see that such a method has a certain number of advantages relative to those implemented in the state of the art, since they make it possible, from change analyses in views of a scene, to deduce control orders of an image display on a screen.

Similarly to what was described previously, in the described example, the scene is a scene of the environment opposite the information display screen and which for example incorporates a part such as the head of the user.

Of course, the viewing means of the environment may be arranged in another orientation for example to acquire views of the environment in front of the terminal or the like.

1. A method for controlling the display of at least one image on at least one screen of a terminal associated with means for viewing a scene, characterized in that it includes a step of establishing a reference display configuration in which the display of the image is associated with the view of the scene output by the viewing means, and a step of detecting changes in the view of the scene output by the viewing means, in order to control changes to the display of the image on the screen accordingly.

2. The control method according to claim 1, characterized in that the detection step further consists of detecting:
a change in the view of the scene at the output of the viewing means consisting, along an axis substantially perpendicular to the plane of the screen and/or along an aiming axis of the viewing means, of a translation in one direction or another from a reference position corresponding to the reference view, to modify the display enlargement/reduction factor of the image on the screen accordingly,
a change in the view of the scene at the output of the viewing means, in a plane substantially parallel to that of the screen and/or in a plane substantially perpendicular to an aiming axis of the viewing means, in one direction or another from a reference position corresponding to the reference view, to modify a region of interest of the image, displayed on the screen, accordingly,
a rotation of the view of the scene at the output of the viewing means, around an axis substantially perpendicular to the plane of the screen and/or an aiming axis of the viewing means, in one direction or the other from a reference position corresponding to the reference view, to command a rotation of the image displayed on the screen accordingly, and/or
an angular pivoting of the view of the scene at the output of the image acquisition means, in one direction or the other from a reference position corresponding to the reference view, around an axis comprised in the plane of the screen or perpendicular to the aiming axis, to command a translation of the image displayed on the screen accordingly.

3. The control method according to claim 1, characterized in that it is activated by an action by a user of the terminal.

4. The control method according to claim 3, characterized in that the activation action by the user is an action on the screen of the terminal.

5. The control method according to claim 3, characterized in that the activation action by the user is an action on a pushbutton of the terminal.

6. The control method according to claim 1, characterized in that the scene is the environment opposite the screen (2).

7. The control method according to claim 6, characterized in that the environment scene opposite the screen incorporates the head of a user of the terminal.

8. A system for controlling the display of at least one image on at least one screen of a terminal associated with means for viewing a scene, for implementing a method according to claim 1, characterized in that it includes means for establishing a reference display configuration in which the display of the image is associated with the view of the scene output by the viewing means, and means for detecting changes in the view of the scene output by the viewing means, in order to control changes to the display of the image on the screen accordingly.

9. A user terminal, provided with a system for controlling a display according to claim 8.

10. The user terminal according to claim 9, characterized in that it includes integrated viewing means.

11. The user terminal according to claim 9, characterized in that it includes remote viewing means connected to it by connection means.

12. The user terminal according to claim 11, characterized in that the connection means are chosen from the group comprising connection means that are:
wired,
wireless,
infrared.

13. The user terminal according to claim 9, characterized in that it is chosen from the group comprising:
an information display monitor,
a computer,
a tablet,
a smart watch,
a smartphone.
